(19) United States
(12) Patent Application Publication
(10) Pub. No.: US 2011/0149037 A1
(43) Pub. Date: Jun. 23, 2011

(54) Method and system for encoding a 3D video signal, encoder for encoding a 3-D video signal, encoded 3D video signal, method and system for decoding a 3D video signal, decoder for decoding a 3D video signal.

(75) Inventors: Jan Van Der Horst, Eindhoven (NL); Bart Gerard Bernard Barenbrug, Waalre (NL); Gerardus Wilhemus Theodorus Van Der Heiden, Haaren (NL)

(73) Assignee: Koninklijke Philips Electronics N.V., Eindhoven (NL)

(21) Appl. No.: 13/059,998

(22) PCT Filed: Aug. 17, 2009
(86) PCT No.: PCT/IB2009/053608

§ 371 Date: Feb. 21, 2011

(30) Foreign Application Priority Data
Aug. 26, 2008 (EP) 08162924.8

(51) Int. Cl. H04N 13/00

(52) U.S. Cl. 348/43; 348/E13.062

(57) ABSTRACT

In a method for encoding and an encoder for a 3D video signal, a principal data layer, a depth map for the principal data layers and further data layers are encoded. Several data layers are combined in one or more common data layers by moving data segments such as data blocks from data layers of origin into common data layers and keeping record of the shift in an additional data stream.

### FIELD OF THE INVENTION

The invention relates to the field of video encoding and decoding. It presents a method, system and encoder for encoding a 3D video signal. The invention also relates to a method, system and decoder for decoding a 3D video signal. The invention also relates to an encoded 3D video signal.

### BACKGROUND OF THE INVENTION

Recently there has been much interest in providing 3-D images on 3-D image displays. It is believed that 3-D imaging will be, after color imaging, the next great innovation in imaging. We are now at the advent of introduction of 3D displays for the consumer market.

A 3-D display device usually has a display screen on which the images are displayed.

Basically, a three dimensional impression can be created by using stereo pairs, i.e. two slightly different images directed at the two eyes of the viewer.

There are several ways to produce stereo images. The images may be time multiplexed on a 2D display, but this requires that the viewers wear glasses with e.g. LCD shutters. When the stereo images are displayed at the same time, the images can be directed to the appropriate eye by using a head mounted display, by using polarized glasses (the images are then produced with orthogonally polarized light) of by using shutter glasses. The glasses worn by the observer effectively route the respective left or right view to the respective eye. Shutters or polarizer's in the glasses are synchronized to the frame rate to control the routing. To prevent flicker, the frame rate must be doubled or the resolution halved with respect to the two dimensional equivalent image. A disadvantage of such a system is that glasses have to be worn to produce any effect. This is unpleasant for those observers who are not familiar with wearing glasses and a potential problem for those already wearing glasses, since the additional pair of glasses does not always fit.

Instead of near the viewer's eyes, the images can also be split at the display screen by means of a splitting screen such as a lenticular screen, such as e.g. known from U.S. Pat. No. 6,118,584 or a parallax barrier as e.g. shown in U.S. Pat. No. 5,969,850. Such devices are called auto-stereoscopic displays since they provide an (auto-) stereoscopic effect without the use of glasses. Several different types of auto-stereoscopic devices are known.

Whatever type of display is used, the 3-D image information has to be provided to the display device. This is usually done in the form of a video signal comprising digital data.

Because of the massive amounts of data inherent in digital imaging, the processing and/or the transmission of digital image signals form significant problems. In many circumstances the available processing power and/or transmission capacity is insufficient to process and/or transmit high quality video signals. More particularly, each digital image frame is a still image formed from an array of pixels.

The amounts of raw digital information are usually massive requiring large processing power and/or or large transmission rates which are not always available. Various compression methods have been proposed to reduce the amount of data to be transmitted, including for instance MPEG-2, MPEG-4 and H.264.

These compression methods have originally been set up for standard 2D videos/image sequences.

When the content is displayed on an autostereoscopic 3D display multiple views must be rendered and these are sent in different directions. A viewer will have different images on the eyes and these images are rendered such that the viewer perceives depth. The different views represent different viewing angles. However, on the input data usually only one viewing angle is visible. Therefore the rendered views will have missing information in the regions behind e.g. foreground objects or information on the side of objects. Different methods exist to cope with this missing information. One method is adding additional viewpoints from different angles (including corresponding depth information) from where views in between can be rendered. However this will increase the amount of data greatly. Also in complicated pictures more than one additional viewing angle is needed, yet again increasing the amount of data. Another solution is to add data to the image in the form of occlusion data representing part of the 3D image that is hidden behind foreground objects. This background information is stored from either the same or also a side viewing angle. All of these methods require additional information wherein a layered structure for the information is most efficient.

There may be many different further layers of further information if in a 3D image many objects are positioned behind each other. The amount of further layers can grow significantly, adding massive amounts of data to be generated. Further data layers can be of various types, all of which are, within the framework of the invention denoted as further layers. In a simple arrangement all objects are opaque. Background objects are then hidden behind foreground objects and various background data layers may be necessary to reconstruct the 3D image. To provide for all information the various layers of which the 3D image is composed must be known. Preferable with each of the various background layers also a depth layer is associated. This creates one further type of further data layers. One step more complex is a situation in which one or more of the objects are transparent. In order to reconstruct a 3D image one then needs the color data, as well as the depth data, but also has transparency data for the various layers of which the 3D image is composed. This will allow 3D images in which some or all of the objects are transparent to be reconstructed. Yet one step further would be to assign to the various objects transparency data, optionally also angle dependent. For some objects the transparency is dependent on the angle at which one looks through an object, since at right angle the transparency of an object is generally more than at an oblique angle. One way of supplying such further data is supplying thickness data. This would add yet further layers of yet further data. In a highly complex embodiment transparent objects could have a lensing effect, and to each layer a data layer giving lensing effect data would be attributed. Reflective effects, for instance specular reflectivity form yet another set of data.

Yet further additional layers of data could be data from side views.

If one stands before an object such as a cupboard, the side wall of the object may be invisible; even if one adds data of objects behind the cupboard, in various layers, these data layers would still not enable to reconstruct an image on a side wall. By adding side view data, preferably from various side view points of view (to the left and right of the principal view), side wall images may also be reconstructed. The side view information may in itself also comprise several layers of information, with data such as color, depth, transparency, thickness in relation to transparency etc etc. This adds yet again more further layers of data. In a multi-view representation the number of layers can increase very rapidly.

As more and more effects or more and more views are added to provide a more and more realistic 3D rendering, more and more further data layers are needed, both in the sense of how many layers of objects there are, as well as the number of different types of data that are assigned to each layer of objects.

As said, various different types of data can be layered, relatively simple ones being the color, and depth data, and more complex types being transparency data, thickness, (specular) reflectivity.

It is thus an object of the invention to provide a method for encoding 3D image data wherein the amount of data to be generated is reduced without, or with only a small, loss of data. Preferably the coding efficiency is large. Also, preferably, the method is compatible with existing encoding standards.

It is a further object to provide an improved encoder for encoding a 3D video signal, a decoder for decoding a 3D video signal and a 3D video signal.

### SUMMARY OF THE INVENTION

To this end the method for encoding in accordance with the invention is characterized in that an input 3D video signal is encoded, the input 3D video signal comprising a principal video data layer, a depth map for the principal video data layer and comprising further data layers for the principal video data layer, wherein data segments, belonging to different data layers of the principal video data layer, the depth map for the principal video layer and the further data layers, are moved to one or more common data layers, and wherein an additional data stream is generated comprising additional data specifying the original position and/or the original further layer for each moved data segment.

The principal video data layer is the data layer which is taken as the basis. It is often the view that would be rendered on a 2D image display. Often this view will be the central view comprising the objects of the central view. However, within the framework of the invention, the choice of the principal view frame is not restricted hereto. For instance, in embodiments, the central view could be composed of several layers of objects, wherein the most relevant information is carried not by the layer comprising those objects that are most in the foreground, but by a following layer of objects, for instance a layer of objects that are in focus, while some foreground objects are not. This may for instance be the case if a small foreground object is moved between the point of view and the most interesting objects,

Within the framework of the invention further layers for the principal video data layer are layers that are used, in conjunction with the principal video data layer, in the reconstruction of a 3 D-video. These layers can be background layers, in case the principal video data layer depicts foreground objects, or they can be foreground layers in case the principal video data layer depicts background objects, or foreground as well as background layers, in case the principal video data layer comprises data on objects between foreground and background objects.

These further layers can comprise background/foreground layers for the principal video data layer, for the same point of view, or comprise data layers for side views, to be used in conjunction with the principal video data layer.

The various different data that can be provided in the further layers are mentioned above and include:

color data

depth data

transparency data

reflectivity data

scale data

In preferred embodiments the further layers comprise image and/or depth data and/or further data from the same point of view as the view for the principal video data layer.

Embodiments within the framework of the invention also encompass video data from other view points, such as present in multi-view video content. Also in the latter case layers/views can be combined since large parts of the side views can be reconstructed from a centre image and depth, so such parts of side views can be used to store other information, such as parts from further layers.

An additional data stream is generated for the segments moved from a further layer to a common layer. The additional data in the additional data stream specifies the original position and/or original further layer for the segment. This additional stream enables reconstructing the original layers at the decoder side.

In some cases moved segments will keep their x-y position and will only be moved towards the common layer. In those circumstances it suffices that the additional data stream comprises data for a segment specifying the further layer of origin.

Within the framework of the invention the common layer may have segments of the principal data layer and segments of further data layers. An example is a situation wherein the principal data layer comprises large parts of sky. Such parts of the layer can often easily be represented by parameters, describing the extent of the blue part and the color (and possibly for instance a change of the color). This would create space on the principal layer into which data from further layers can be moved. This could allow the number of common layers to be reduced.

Preferred embodiment, in respect of backward compatibility, are embodiments in which common layers comprise only segments of further layers.

Not changing the principal layer, and preferably also not changing the depth map for the principal layer, allows for an easy implementation of the method on existing devices.

Segments, within the framework of the invention, may take any form, but in preferred embodiments the data is treated on a level of granularity corresponding to a level of granularity of the video coding scheme, such as e.g. on the macroblock level.

Segments or blocks from different further layers can have identical x-y positions within the original different further layers, for instance within different occlusion layers. In such embodiments the x-y position of at least some segments within the common layer is reordered and at least some blocks are re-located, i.e. their x-y position is shifted to a yet empty part of the common data layer. In such embodiments the additional data stream provides for a segment, apart from data indicating the originating layer, also data indicating the re-location. The re-location data could be for instance in the form of specifying the original position within the original layer, or the shift in respect of the present position. In some embodiment the shift may be the same for all elements of a further layer.

The move to a common layer, including possible relocation, is preferably done at the same position in time, wherein re-location is done in an x-y plane. However, in embodiments the move or re-location can also be performed along the temporal axis: if within a scene a number of trees is lined up and the camera pans such that at one point in time those trees line up, there is a short period with a lot of occlusion data (at least many layers): in embodiments some of those macroblocks may be moved to the common layers of previous/next frames. In such embodiments the additional data stream associated with a moved segment specifies the original further layer data includes a time indication.

The moved segments may be extended areas, but relocating is preferably done on one or more macroblock basis. The additional stream of data will preferably be encoded comprising information for every block of the common layer, including their position within the original further layer. The additional stream may have also additional information which further specifies extra information about the blocks or about the layer they come from. In embodiments the information about the original layer may be explicit, for instance specifying the layer itself; however in embodiments the information may also be implicit.

In all cases, the additional streams will be relatively small due to the fact that a single data-element describes all the 16×16 pixels in a macroblock or even more pixels in a segment exclusively and at the same time. The sum of effective data has increased a little, however the amount of further layers is significantly reduced, which reduces the overall data amount.

The common layer(s), plus the additional stream or additional streams, can then travel for instance over a bandwidth limited monitor interface and be reordered back to it's original multilayer form in the monitor itself (i.e. the monitor firmware) after which these layers can be used to render a 3D image. The invention allows the interface to carry more layers with less bandwidth. A cap is now placed on the amount of additional layer data and not on the amount of layers. Also this data stream can be efficiently placed in a fixed form of image type data, so that it remains compatible with current display interfaces.

In preferred embodiments common layers comprise data segment of the same type.

As explained above, the further layers may comprise data of various types, such as color, depth, transparency etc.

Within the framework of the invention, in some embodiments, data of various different types are combined in a common layer. Common layers can then comprise segments comprising for instance color data, and/or segments comprising depth data, and/or transparency data. The additional data stream will enable the segments to be disentangled and the various different further layers to be reconstructed. Such embodiments are preferred in situations were the number of layers is to be reduced as much as possible.

In simple embodiments common layers comprise data segment of the same type. Although this will increase the number of common layers to be sent these embodiments allow at the reconstruction side a less complex analysis, since each common layer comprises data of a single type only. In other embodiments common layers comprise segments with data of a limited number of data types. The most preferred combination is color data and depth data, wherein other types of data are placed in separate common layers.

The moving of a segment from a further data layer to a common data layer can be performed in different embodiments of the invention in different phases, either during content creation where they are reordered at macroblock level (macroblocks are specifically optimal for 2D video encoders) and then encoded before the video encoder, or at the player side, where multiple layers are decoded and then in real time at a macroblock or larger segment level reordered. In the first case the generated reordering coordinates should also have to be encoded in the video stream. A drawback can be that this reordering can have negative influence on video encoding efficiency. In the second case a drawback is that there is no full control over how the reordering takes place. This is specifically a problem when there are too many macroblocks for the amount of possible common layers on the output and macroblocks have to be thrown away. A content creator would probably want control over what is thrown away and what not. A combination between these two is also possible. For example encoding all layers as is and additionally store displacement coordinates which later the player can use to actually displace the macroblocks during playback. The latter option will allow for control over what can be displayed and will allow for traditional encoding.

In further embodiments the amount of data for the standard RGB+D image is further reduced by using reduced color spaces, and this way having even more bandwidth so that even more macroblocks can be stored in image pages. This is for example possible by encoding the RGBD space into YUVD space, where the U and V are subsampled as is commonly the case for video encoding. Applying this at a display interface can create room for more information. Also backwards compatibility could be dropped so that the depth channel of a second layer can be used for the invention. Another way to create more empty space is to use a lower resolution depth map, so that there is room outside of the extra depth information to store for example image and depth blocks from a 3^{rd} layer. In all of these cases, extra information at macroblock or segment level can be used to encode the scale of the segments or macroblocks.

The invention is also embodied in a system comprising an encoder and in an encoder for encoding a 3D video signal, the encoded 3D video signal comprising a principal video data layer, a depth map for the principal video data layer and further data layers for the principal video data layer, wherein the encoder comprises inputs for the further layers, the encoder comprises a creator, which combines data segments from more than one further layer into one or more common data layers by moving data segments of different further data layers in a common data layer and generating an additional data stream comprising identifying the origin of the moved data segments.

In a preferred embodiment the blocks are only relocated horizontally so that instead of a full and fast frame-buffer only a small memory the size of about 16 lines would be required by a decoder. If the required memory is small, embedded memory can be used. This memory is usually much faster, but smaller, then separate memory chips. Preferably also data is generated specifying the originating occlusion layer. However, this data may also be deduced from other data such as depth data.

It has been found that a further reduction in bits can be obtained by downscaling the further data, differently from the principal layer. Downscaling of the data in the occlusion data especially for deeper laying layers has shown to have only a limited effect on the quality, while yet reducing the number of bits within the encoded 3D signal.

The invention is embodied in a method for encoding, but equally embodied in a corresponding encoder having means for performing the various steps of the method. Such means may be provided in hard-ware or soft-ware or any combination of hard-ware and soft-ware or shareware.

The invention is also embodied in a signal produced by the encoding method and in any decoding method and decoder to decode such signals.

In particular the invention is also embodied in a method for decoding an encoded video signal wherein a 3D video signal is decoded, the 3D video signal comprising an encoded principal video data layer, a depth map for the principal video data layer and one or more common data layers comprising segments originating from different original further data layers and an additional data stream comprising additional data specifying origin of the segments in the common data layers wherein the original further layers are reconstructed on the basis of the common data layer and the additional data stream and a 3D image is generated.

The invention is also embodied in a system comprising a decoder for decoding an encoded video signal wherein a 3D video signal is decoded, the 3D video signal comprising an encoded principal video data layer, a depth map for the principal video data layer and one or more common data layers comprising segments originating from different original additional further data layers and an additional data stream comprising additional data specifying the origin of the segments in the common data layers wherein the decoder comprises a reader for reading the principal video data layer, the depth map for the principal video data layer, the one or more common data layers and the additional data stream, and reconstructor for reconstructing the original further layers on the basis of the common data layer and the additional data stream.

The invention is also embodied in a decoder for such a system.

The origin of the data segments in, within the framework of the invention, the data layer from which the data segments originated and the position within the data layer. The origin may also indicate the type of data layer as well as the time slot, in case data segments are moved to common layers at another time slot.

These and further aspects of the invention will be explained in greater detail by way of example and with reference to the accompanying drawings, in which

### BRIEF DESCRIPTION OF THE DRAWINGS

FIG. 1 illustrates an example of an auto-stereoscopic display device,

FIGS. 2 and 3 illustrate the occlusion problem,

FIG. 4 shows a left and a right view of a computer generated scene,

FIG. 5 illustrates a representation of FIG. 4 in four data maps; principal view, depth map for principal view and two further layers, the occlusion data and depth data for the occlusion data,

FIGS. 6 to 9 illustrate the basic principle of the invention,

FIG. 10 illustrates an embodiment of the invention,

FIG. 11 illustrates a further embodiment of the invention,

FIG. 12 provides a block scheme for an embodiment of the invention

FIGS. 13 and 14 illustrate an encoder and decoder in accordance with the invention.

FIG. 15 illustrate an aspect of the invention

FIG. 16 illustrates an embodiment of the invention in which the data segments of the principal layer are moved to a common layer.

The figures are not drawn to scale. Generally, identical components are denoted by the same reference numerals in the figures.

### DETAILED DESCRIPTION OF PREFERRED EMBODIMENTS

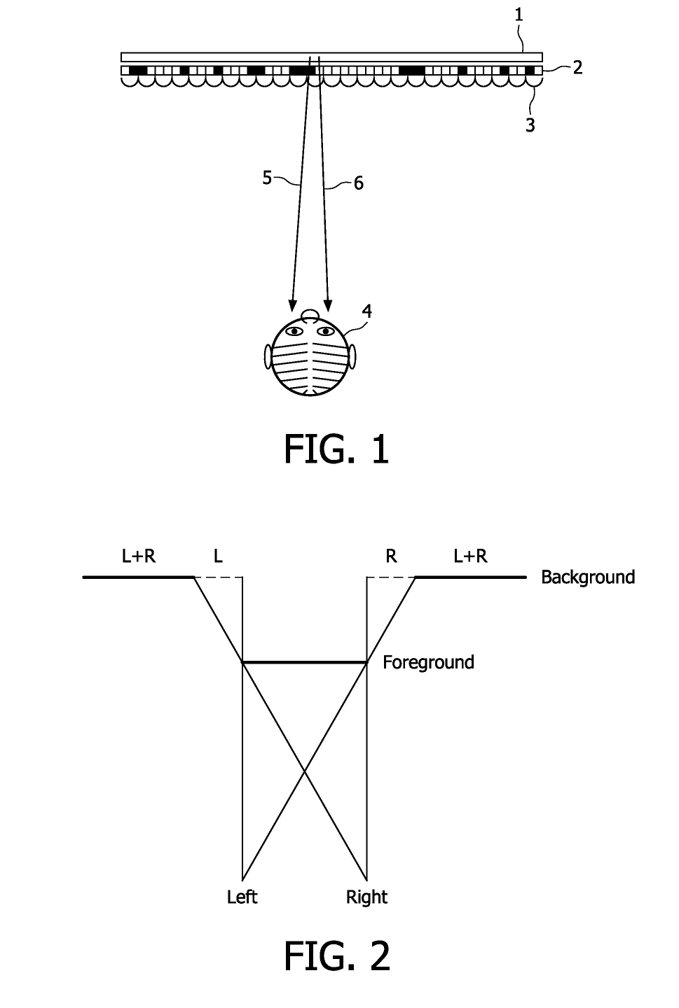

FIG. 1 illustrates the basic principle of a type of auto-stereoscopic display device. The display device comprises a lenticular screen 3 for forming two stereo images 5 and 6. The vertical lines of two stereo images are (spatially) alternatingly displayed on, e.g., a spatial light modulator 2 (e.g. a LCD) with a backlight 1. Together the back light and the spatial light modulator form a pixel array. The lens structure of the lenticular screen 3 directs the stereo image to the appropriate eye of the viewer. In this example two images are shown. The invention is not restricted to a two view situation; in fact the more views are to be rendered, the more information is to be encoded and the more the present invention is useful. However, for ease of explanation, in FIG. 1 a two view situation is depicted. It is noted, that an important advantage of the invention is that multiple (types of) layers also allow wider sideview capabilities and/or large depth range displays since it allows more efficient decoding and storing of wide viewing cones.

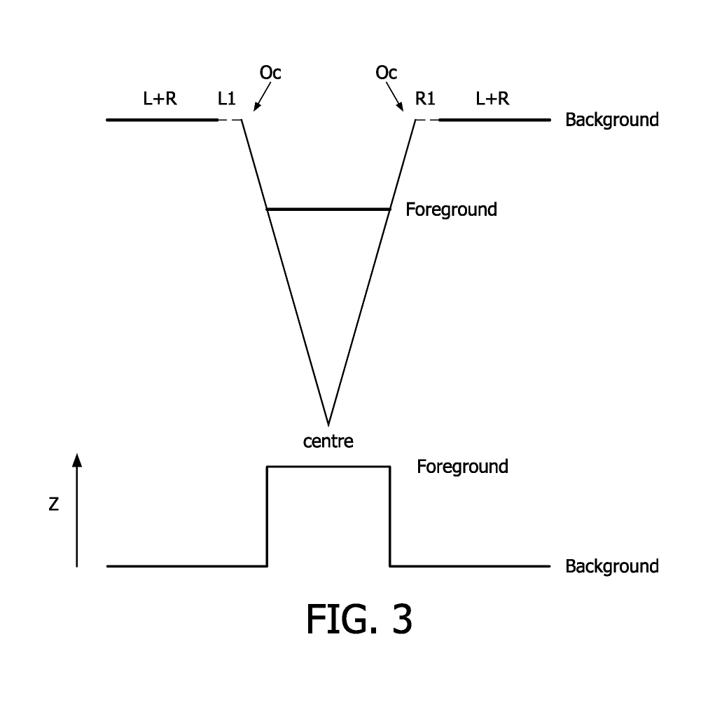

In FIGS. 2 and 3 the occlusion problem is illustrated. The line indicated with Background in this figure is the background and the line indicated with Foreground represents an object that is located in front of the background. Left and Right represent two views of this scene. These two views can be, for example, the left and the right view for a stereo set-up, or the two most outer views for the case of usage of an n-view display. The lines denoted L+R can be observed by both views, whereas the L part can only be observed from the Left view and the R part only from the Right view. Hence the R part cannot be observed from the Left view, and similarly the L part cannot be observed from the Right view. In FIG. 3 centre indicates the principal view. As can be seen from this figure part (L1 respectively R1) of the L and R part of the background indicated in FIG. 3 can be seen from the principal view. However, a part of the L and R part is invisible from the principal view since it is hidden behind the foreground object. These areas indicated with Oc are areas that are occluded for the principal view but would be visible from the left and right views. As can be seen from the figure, the occlusion areas typically occur at the edges of foreground objects. When only using a 2D+Depth image certain parts of the 3D image cannot be reconstructed. Generating 3-D data only from a principal view and a depth map poses a problem for the occluded areas. The data of parts of the image hidden behind foreground objects is unknown. A better rendition of 3D image can be obtained by adding information of objects hidden behind other objects in the principal view. There may be many objects hidden behind each other, so the information is best layered. For each layer not only the image data but also the depth data is best provided. In case objects are transparent and/or reflective data on these optical quantities should also be layered. In fact, for an even more truthful rendition it is in addition possible to provide the information on various layers of objects for side views too. Moreover in case the number of views and accuracy of 3D rendition is to be improved, it is also possible to encode more than a center view, e.g. the left and right view, or even more views.

Better depth maps will enable display on high-depth and large angle 3D displays. Increase in depth reproduction will result in visible imperfection around depth discontinuities due to the lack of occlusion data. Therefore for high quality depth maps and high depth displays, the inventors have realized a need for accurate and additional data. It is remarked that “depth map” is to be interpreted, within the framework of the invention broadly, as being constituted of data providing information on depth. This could be in the form of depth information (z-value) or disparity information, which is akin to depth. Depth and disparity can be easily converted into one another. In the invention such information is all denoted as “depth map” in whichever form it is presented.

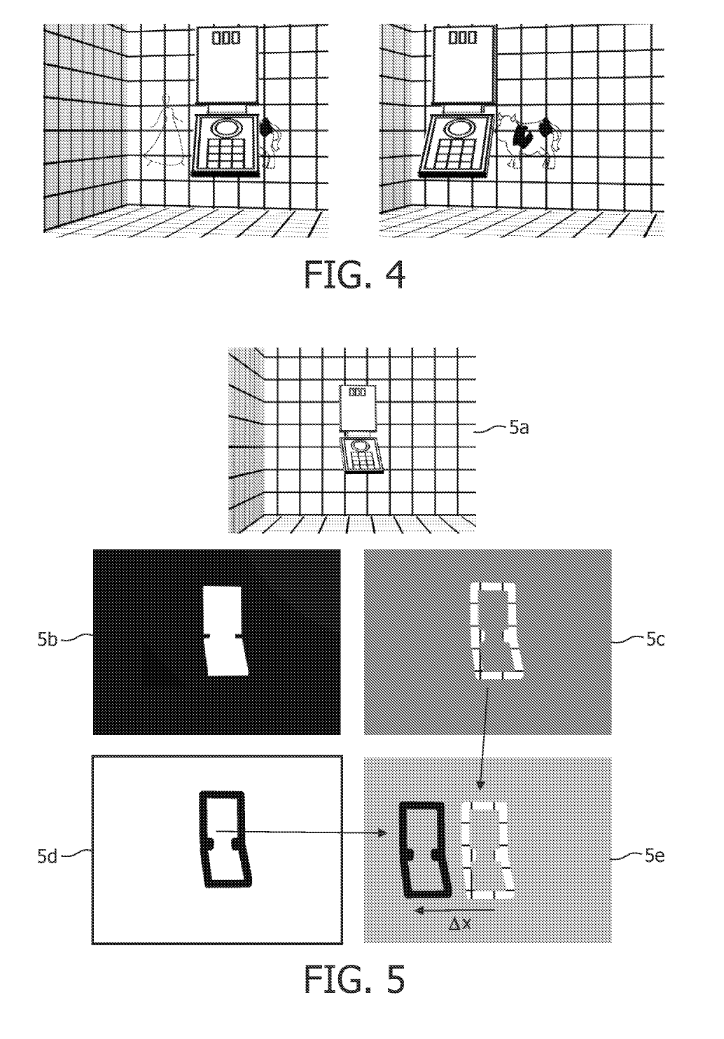

FIG. 4 shows a left and a right view of a computer generated scene. The mobile phone is floating in a virtual room with a yellow tiled floor and two walls. In the left view a female is clearly visible, whereas she is not visible in the right view. The opposite holds for the brown cow in the right view.

In FIG. 5 we have the same scene as discussed above with respect to FIG. 4. The scene is now, in accordance with the invention, represented by four data maps,
a map with the image data for the principal view (5a),
the depth map for the principal view (5b),
the image data for the occlusion map for the principal view (5c), i.e. the part of the image hidden behind the foreground object and
the depth data for the occlusion data (5d).

The extent of the functional occlusion data is determined by the principal view depth map and the depth range/3D cone of the intended 3D display-types. Basically it follows the lines of steps in depth in the principal view. The areas comprised in the occlusion data, color (5a) and depth (5d), are formed in this example by bands following the contour of the mobile phone. These bands (which thus determines the extent of the occlusion areas) may be determined in various ways:
as a width following from a maximum range of views and the step in depth.
as a standard width
as a width to be set
as anything in the neighborhood of the contour of the mobile phone (both outside and/or inside). Within the framework of the invention, in this example there are two further layers, the layer represented by 5c, the image data and by 5d, the depth map.

FIG. 5a illustrates the image data for the principal view, 5b the depth data for the principal view.

The depth map 5b is a dense map. In the depth map light parts represent objects that are close and the darker parts represent objects that are farther away from the viewer.

Within the example of the invention illustrated in FIG. 5, the functional further data is limited to a band having a width which corresponds to the data to what one would see given a depth map and a maximum displacement to the left and right. The remainder of the data in the layers 5c and 5d, i.e. the empty area outside the bands is not functional.

Most of the digital video coding standards support additional data channels that can be either at video level or at system level. With these channels available, transmitting of further data can be straightforward.

FIG. 5e illustrates a simple embodiment of the invention: the data of further layers 5c and 5d are combined into a single common further layer 5e. The data of layer 5d in inserted in layer 5c and is shifted horizontally by a shift Δx. Instead of two further data layers 5c and 5d, only one common layer of further data 5e is needed, plus an additional data stream, which data stream for the data from 5d comprises, the shift Δx, segment information identifying the segment to be shifted and the origin of the original layer, namely layer 5d, indicating that it is depth data. At the decoder side this information enables a reconstruction of all four data maps, although only three data maps have been transferred.

It will be clear to the skilled person that the above encoding of displacement information is merely exemplary, data may be encoded using e.g. source position and displacement, target position and displacement or source and target position alike. Although the example shown here requires a segment descriptor indicative of the shape of the segment, segment descriptors are optional. Consider e.g. an embodiment wherein segments correspond with macroblocks. In such an embodiment it suffices to identify the displacement and/or one of source and destination on macro block basis.

In FIG. 5 two further layers, 5c and 5d, are present, which are combined into a common layer 5e. This FIG. 5 is however, a relatively simple figure.

In more complex images several occlusion layers, and their respective depth maps are present, for instance when parts are hidden behind parts which are themselves hidden behind foreground objects.

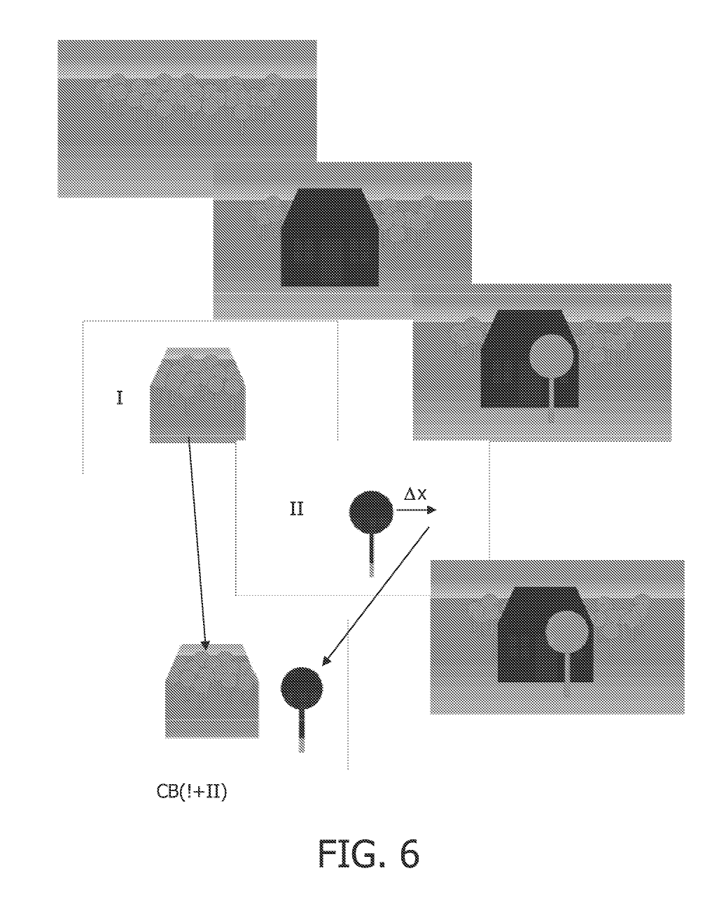

FIG. 6 illustrates a scene. The scene is composed of a forest with a house in front and a tree in front of the house. The corresponding depth maps are omitted: these are treated similarly. In terms of occlusion, this yields an occlusion layer comprising the forest behind the house (I), and an occlusion layer with the house behind the tree (II); the two occlusion layers are in position co-located, so cannot directly be combined into one single layer.

However as indicated in the bottom part of FIG. 6 by shifting the macroblocks which contain the part of the house behind the tree to the right over a distance Δx (and storing the reverse as an offset in their meta-data), the two data segments of occlusion data layers I and II no longer overlap in position and can be combined into a common occlusion layer CB(I+II) by moving them to said common data layer. Consider a scenario wherein displacements are provided on macroblock level.

In the simple case of FIG. 6 there are only 2 offsets (0 offset for the forest behind the house; and a horizontal-offset only for the house behind the tree), so if we make a table of these, the meta-data is just one offset per macroblock. Of course if the offset is zero, the data could be left out, providing that it is known at the decoder side that no re-location data means that the offset is zero. By using a single horizontal offset for the house behind the tree, vertical coherency is maintained (a possibly temporal coherency if this is done across frames, for example within a GOP), which can help compression using standard video codecs.

It is to be noted that if more room was needed, the bottom part of the occlusion data behind the house would be a good candidate to omit, since it can be predicted from the surrounding. The forest trees need to be encoded since they can't be predicted. In this example the depth takes care of ordering the two layers, in complex situation additional information specifying the layer can be added to the meta-data.

In a similar manner, two depth maps of the two occlusion layers can be combined in a single common background depth map layer.

Going one step further, the four additional layers, i.e. the two occlusion layers and their depth maps can be combined into a single common layer.

In the common layer of the two occlusion layers there are still open areas as FIG. 6 shows. In these empty areas of FIG. 6 the depth data for the two occlusion layers can be positioned.

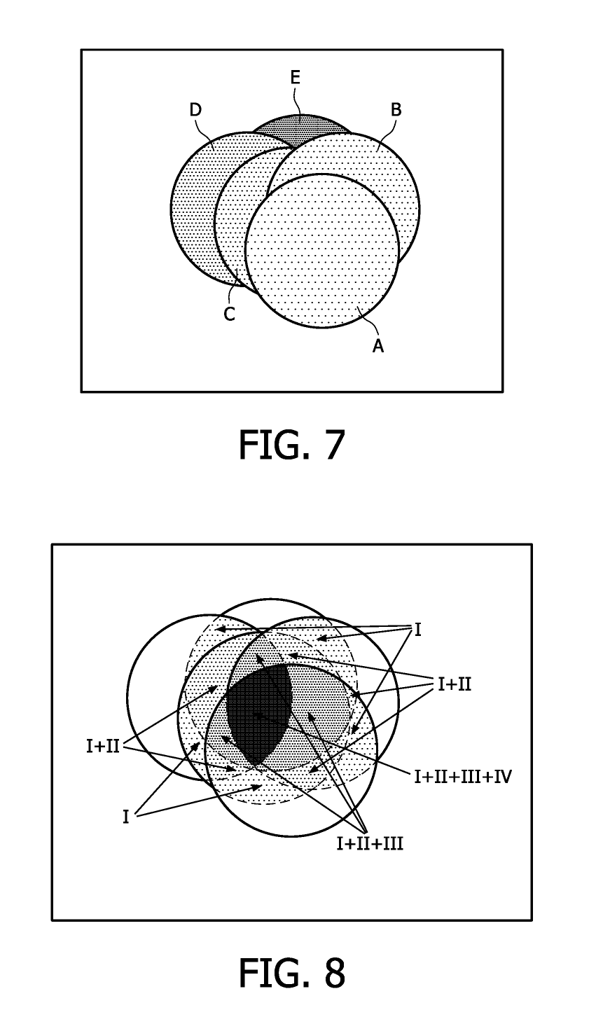

More complex situations are illustrated in FIGS. 7 to 9. In FIG. 7 a number of objects A to E have been placed behind each other. A first occlusion layer gives the data of all the data occluded (as seen by the central view) by foreground objects, and a second occlusion layer for those objects occluded by the first occluded objects. Two to three layers of occlusion are not uncommon in real-life scenes. It can easily be seen that in point X, in fact four layers of background data are present.

A single occlusion layer would not comprise the data for the further occlusion layers.

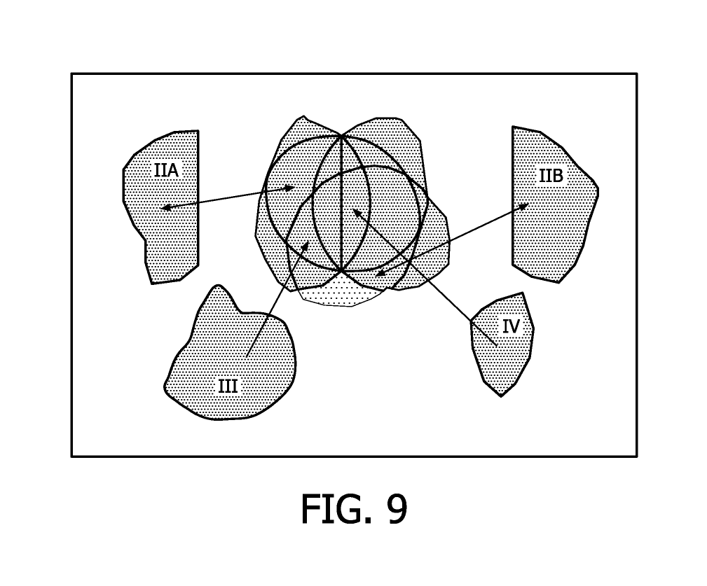

FIG. 8 illustrates the invention further; the first occlusion layer occupies an area given by all shaded areas. This layer comprises, apart from the useful blocks depicting an object occluded by a foreground object, also areas which have no useful information, the white areas. The second occlusion layer lies behind the first occlusion layer and is smaller in size. Instead of dedicating a separate data layer the invention allows to relocate the macroblocks (or more general the data) of the second occlusion layer within the common occlusion layer. This is schematically indicated by the two areas IIA and IIB in FIG. 9. Metadata is provided to give information on the relationship between the original position, and the relocated position. In FIG. 9 this is schematically indicated by an arrow. The same can be done with third layer occlusion data, by relocating area III and the fourth occlusion layer by relocating area IV. Apart from data on relation, especially in this complex embodiment the data preferably also comprises data on the number of the occlusion layer. If there is only one additional occlusion layer, or from other data (such as z-data, see FIG. 6) the ordering is clear, such information may not be necessary. By relocation data segments, for example and preferably for macroblocks, of deeper occlusion layers in a common occlusion layer, and making an additional data stream which keeps track of the relocation and preferably the source occlusion layer, more information can be stored in a single common occlusion layer. The generated meta data makes it possible to keep track of the origin of the various moved data segments, allowing, at the decoder side, to reconstruct the original layer content.

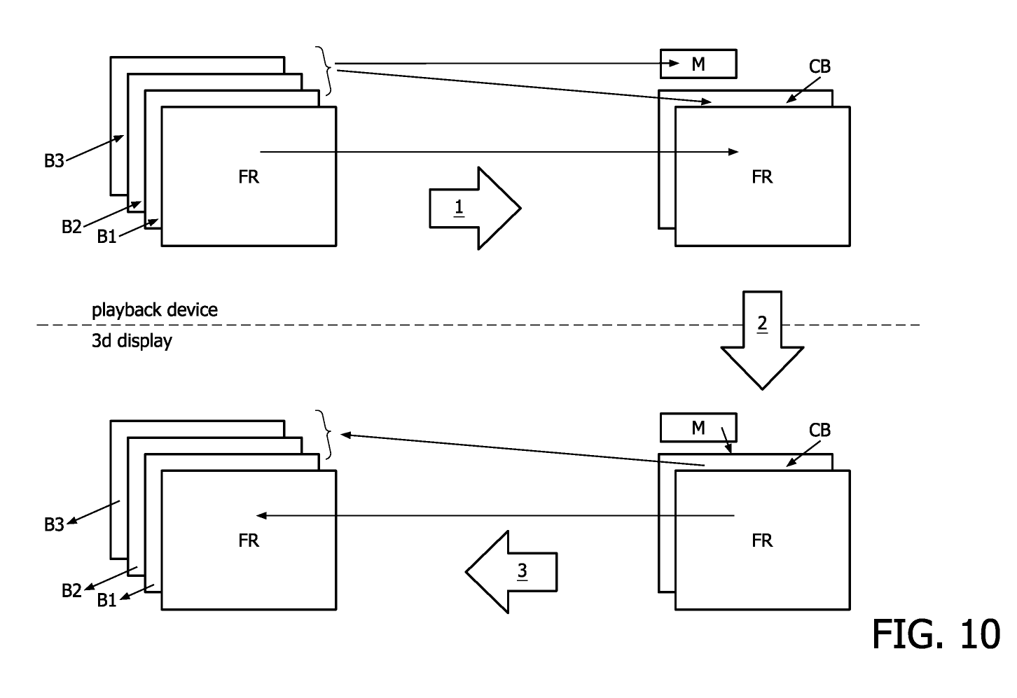

FIG. 10 illustrates an embodiment of the invention further. A number of layers, including a first layer FR i.e. a principal frame, and a number of occlusion layers of a multi-layer representation B1, B2, B3 are combined according to the invention. The layers B1, B2, B3 are combined into a common layer CB (combined image background information). The information indicating how segments are moved is stored in data stream M. The combined layers can now be sent across a display interface (dvi, hdmi, etc) to a 3D device like a 3D display. Within the display, the original layers are reconstructed again for multi-view rendering using the information of M.

It is remarked that in the example of FIG. 10 background layers B1, B2, B3, etc. are illustrated. To each background layer a depth map B1D, B2D, B3D, etc. may be associated. Also a transparency data B1T, B2T, B3T, etc. may be associated. As explained above, each of these sets of layers is, in embodiments, combined into one or more common layers. Alternatively the various sets of layers can be combined into one or more common layers. Also, the image and depth layers can be combined in a first type of common layers, while the other data layers, such as transparency and reflectivity can be combined in a second type of layers.

It is noted that a multi-view rendering device does not have to fully reconstruct the image planes for all layers, but can possibly store the combined layers, and only reconstruct a macroblock level map of the original layers containing pointers to where the actual video data can be found in the combined layers. Meta data M could be generated and/or could be provided for this purpose during encoding.

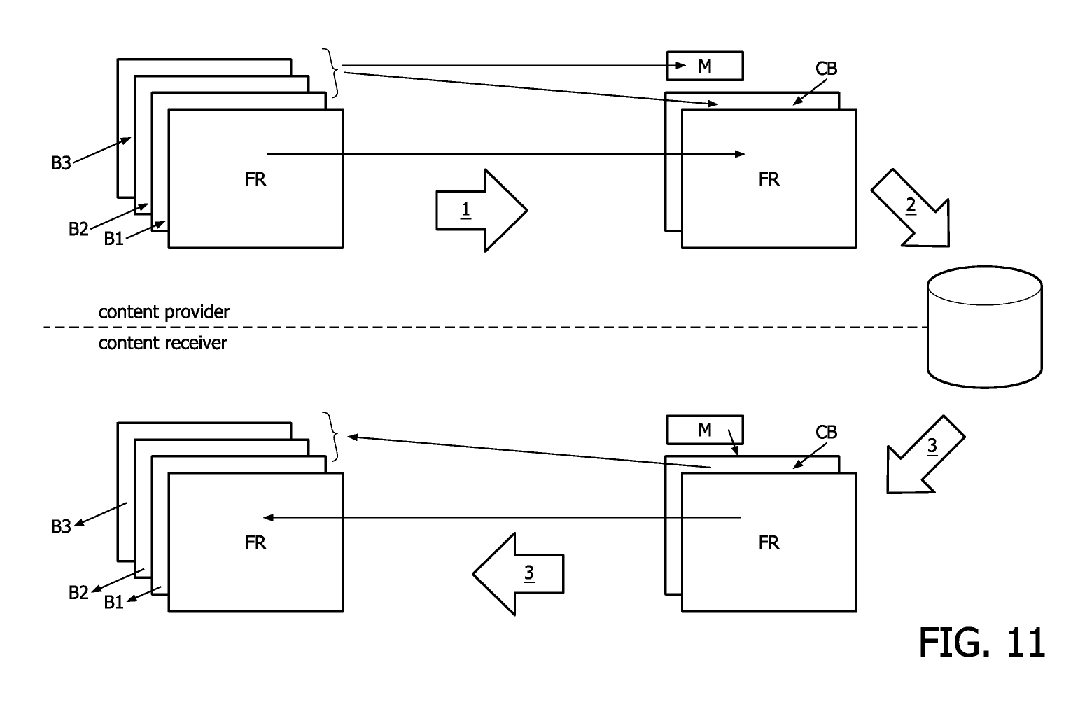

FIG. 11 illustrates another embodiment of the invention.

A number of layers of a multi-layer representation are combined according to the invention.

The combined layers can now be compressed using standard video encoders into fewer video streams (or video streams of less resolution if the layers are tiled), while the meta-data M is added as a separate (lossless compressed) stream. The resulting video file can be sent to a standard video decoder, as long as it also outputs the meta-data the original layers can be reconstructed according to the invention to have them available for, for example, a video player, or for further editing. It is noted that this system and the one from FIG. 10 can be combined to keep the combined layers and send them over a display interface before reconstructing the original layers.

A data layer is, within the framework of the invention, any collection of data, wherein the data comprises for planar coordinates, defining a plane or points in a plane or in a part of a plane, or associated with, paired with and/or stored or generated for planar coordinates, image information data for points an/or areas of the said plane or a part of the said plane. Image information data may be for instance, but is not restricted to color coordinates (e.g. RGB or YUV), z-value (depth), transparency, reflectivity, scale etc..

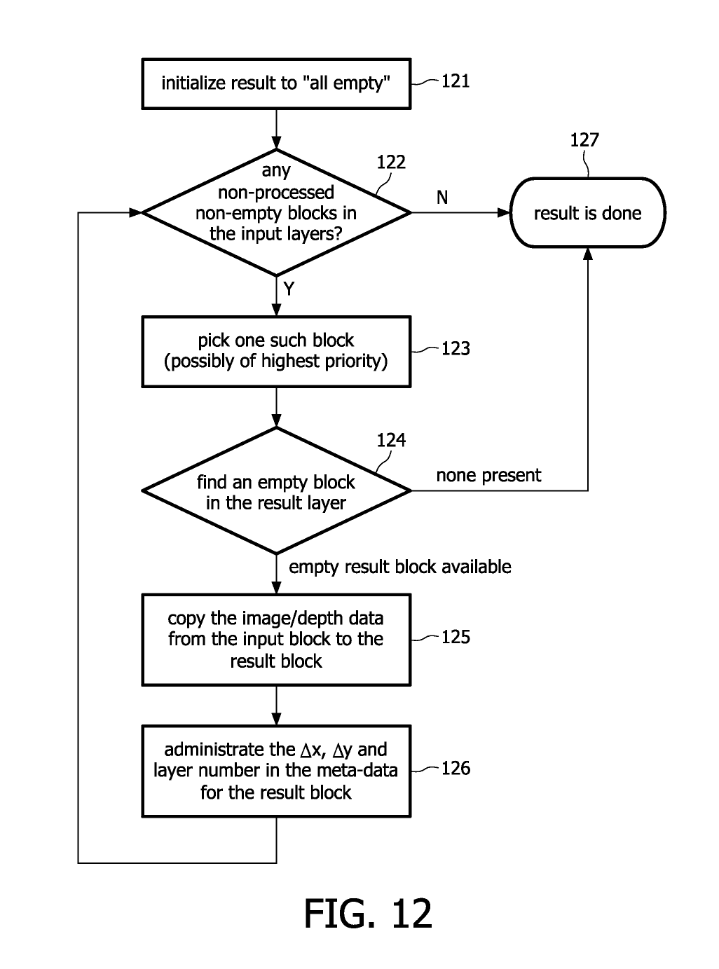

FIG. 12 illustrates a flow diagram of an embodiment for an encoder combining blocks of several further data layers, for instance occlusion layers into a common data layer while generating metadata. The decoder does the reverse, copying the image/depth data to the proper location in the proper layer using the meta-data.

In the encoder blocks can be processed according to priority. For instance in the case of occlusion data, the data that relate to areas which are very far from an edge of a foreground object will rarely be seen, so such data can be given a lower priority than data close to an edge. Other priority criteria could be for instance the sharpness of a block. Prioritizing blocks has the advantages that, if blocks have to be omitted, the least relevant ones will be omitted.

In step 121 the results are initialized to “all empty”. In step 122 it is checked whether any non-processed non-empty blocks are in the input layers. If there are none, the result is done, if there are, one block is picked in step 123. This is preferably done on the basis of priority. An empty block is found in the common occlusion layer (step 124). Step 124 could also precede step 123. If there are no empty blocks present the result is done; if an empty block is present the image/depth data from the input block is copied to the result block in step 125, and the data on the relocation and preferably layer number is administrated in the meta data (step 126), the process is repeated until the result is done.

In a somewhat more complex scheme extra steps may be added to create additional space in case it is found that there are no empty blocks left in the result layer. If the result layer comprises many blocks of similar content, or blocks that can be predicted from surroundings, such blocks can be omitted to make room for additional blocks. For instance the bottom part of the occlusion data behind the house in FIG. 6 would be a good candidate to omit, since it can be predicted from the surrounding.

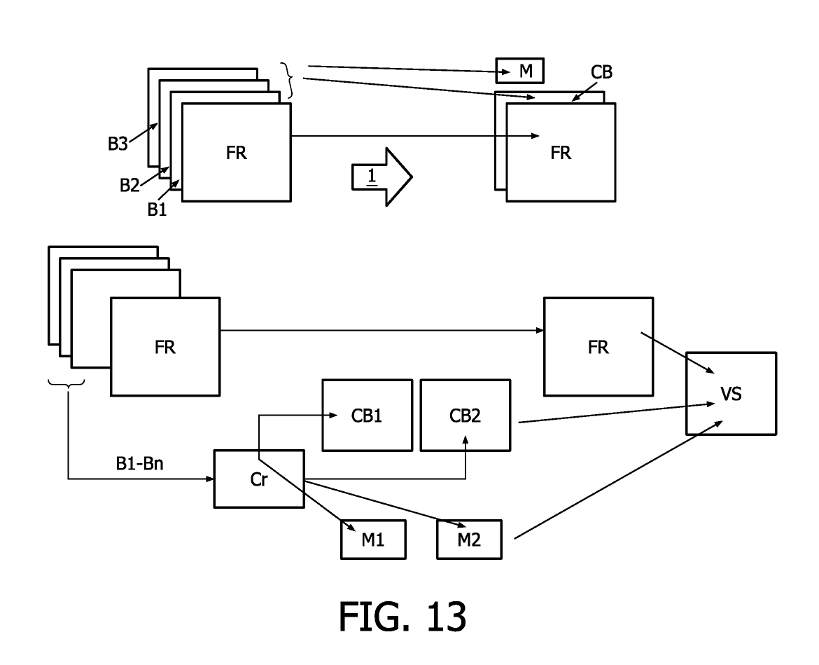

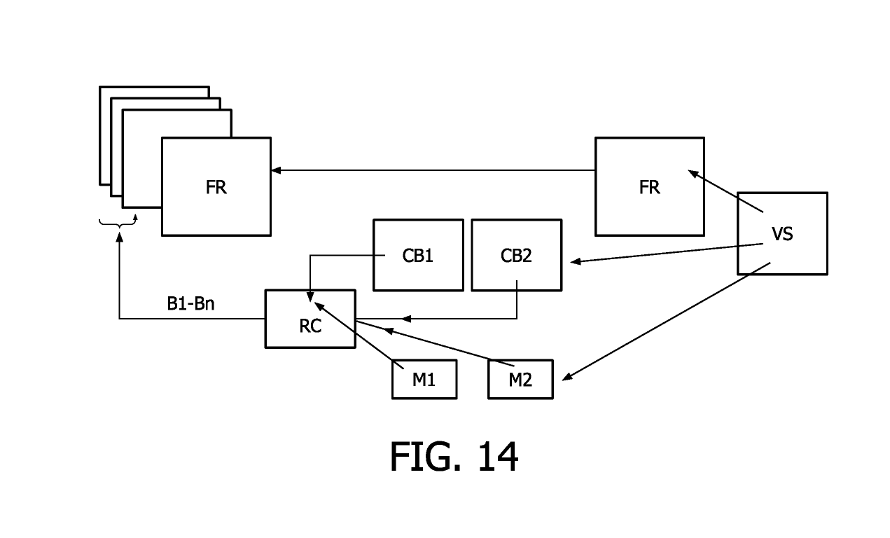

FIGS. 13 and 14 illustrate an encoder and a decoder of embodiments of the invention. The encoder has an input for further layers, for instance occlusion layers B1-Bn. The blocks of these occlusion layers are in this example combined in two common occlusion layers and two datastream (which could be combined into a single additional stream) in creator CR. The principal frame data, the depth map for the principal frame, the common occlusion layers data and the metadata are combined into a video stream VS by the encoder in FIG. 13. The decoder in FIG. 14 does the reverse and has a reconstructor RC.

It is remarked that the metadata can be put in a separate data stream, but the additional data stream could also be put in the video data itself (especially if that video data is not compressed, such as when transmitted over a display interface). Often an image comprises several lines that are never displayed.

If the meta data is small in size, for instance when there are only a small number of Δx, Δy values, where Δx, Δy identifies a general shift for a large number of macroblocks, the information may be stored in these lines. In embodiments a few blocks in the common layer may be reserved for this data, for example the first macroblock on a line contains the meta-data for the first part of a line, describing the meta-data for the next n macroblocks (n depending on the amount of meta-data which can be fitted into a single macroblock). Macroblock n+1 then contains the meta-data for the next n macroblocks, etc.

In short the invention can be described by:

In a method for encoding and an encoder for a 3D video signal, principal frames, a depth map for the principal frames and further data layers are encoded. Several further data layers are combined in one or more common layers by moving data segments of various different layers into a common layer and keeping track of the movements. The decoder does the reverse and reconstructs the layered structure using the common layers and the information on how the data segments are moved to the common layer, i.e. from which layer they came and what their original position within the original layer was.

The invention is also embodied in any computer program product for a method or device in accordance with the invention. Under computer program product should be understood any physical realization of a collection of commands enabling a processor—generic or special purpose—, after a series of loading steps (which may include intermediate conversion steps, like translation to an intermediate language, and a final processor language) to get the commands into the processor, to execute any of the characteristic functions of an invention. In particular, the computer program product may be realized as data on a carrier such as e.g. a disk or tape, data present in a memory, data travelling over a network connection—wired or wireless—, or program code on paper. Apart from program code, characteristic data required for the program may also be embodied as a computer program product.

Some of the steps required for the working of the method may be already present in the functionality of the processor instead of described in the computer program product, such as data input and output steps.

It should be noted that the above-mentioned embodiments illustrate rather than limit the invention, and that those skilled in the art will be able to design many alternative embodiments without departing from the scope of the appended claims.

For instance, the examples given are example in which a centre view is used and occlusion layers comprising data on objects lying behind the foreground objects. Within the framework of the invention an occlusion layer can also be the data in a side view to a principal view.

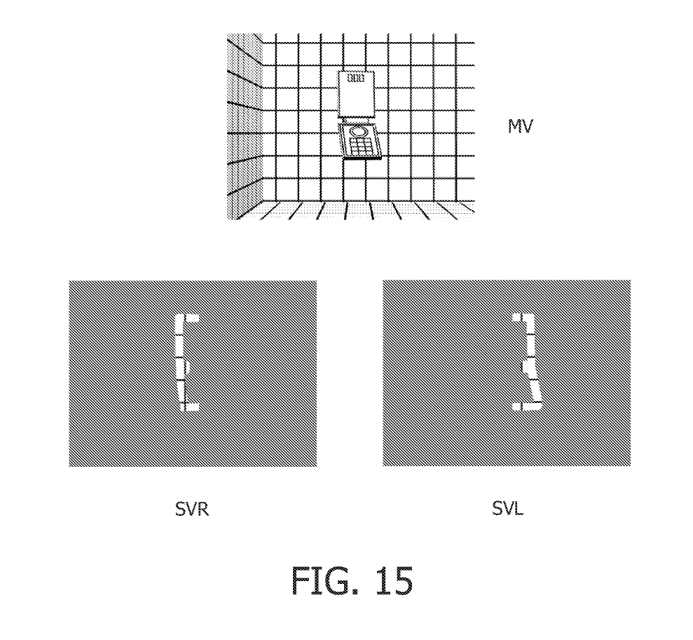

FIG. 15 illustrates a principal view at the top part of the figure; Side views are illustrated at the bottom part of the figure. A side view will comprise all the data of the principal view, but for a small area video data which was occluded in the principal view by the telephone. A side view to the left SVL will include data that is also comprised in the principal view, indicated by the grey area, and a small band of data that was occluded in the principal view, which is shown in grey tones. Likewise, a view to the right of the principal view will have data common with the principal view (shown in grey) and a small band of data (but not the same as for the left view) which was occluded in the principal view. A view even more to the left will comprise a broader band of occluded data. However, at least a part of that occlusion data was already comprised in the left view. The same scheme as shown in FIGS. 10 to 14 can be used to combine the occlusion data of the various views into a combined occlusion data layer. The number of layers (i.e. the number of multi-view frames) can thereby be reduced. In multi-view schemes the principal view can be any of a number of views.

In short the invention can be described as:

In a method for encoding and an encoder for a 3D video signal, a principal data layer, a depth map for the principal data layers and further data layers are encoded. Several data layers are combined in one or more common data layers by moving data segments such as data blocks from data layers of origin into common data layers and keeping record of the shift in an additional data stream.

In the claims, any reference signs moved between parentheses shall not be construed as limiting the claim.

The word “comprising” does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The method of encoding or decoding according to the invention could be implemented and executed on a suitable general purpose computer or alternatively a purpose built (integrated) circuit. Implementation on alternative compute platforms is envisaged. The invention may be implemented by any combination of features of various different preferred embodiments as described above.

The invention can be implemented in various manners. For instance, in the above examples the principal video data layer is left untouched and only data segments of further data layers are combined in common data layers.

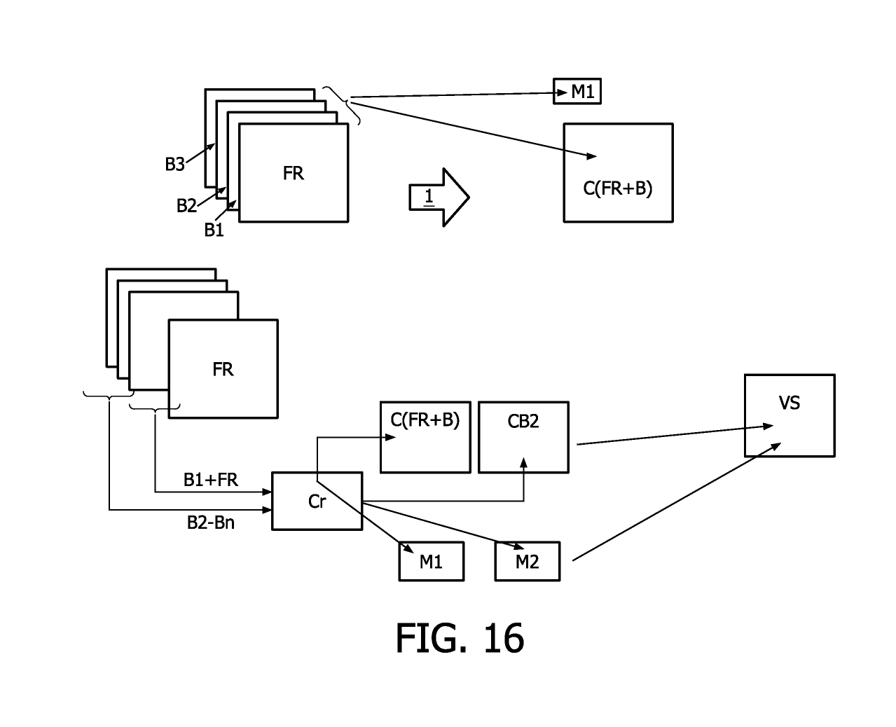

Within the framework of the invention the common layer may also comprise data segments of the principal data layer and segments of further data layers. An example is a situation wherein the principal data layer comprises large parts of sky. Such parts of the principal video data layer can often easily be represented by parameters, describing the extent of the blue part and the color (and possibly for instance a change of the color). This would create space on the principal video data layer into which data segments originating from further data layers can be moved. This could allow the number of common layers to be reduced. FIG. 16 illustrates such an embodiment. The principal layer FR and a first further layer (here denoted B1) are combined into a common layer C(FR+B1) and meta data M1 is generated to keep track of how the data segments of the two layers FR and B1 are moved to the common layer. Further data layers B2 to Bn are combined in common data layer B2 for which meta data M2 is generated.

Preferred embodiments, in respect of backward compatibility, are embodiments in which common layers comprise only segments of further layers (B1, B1T etc).

Not changing the principal layer, and preferably also not the depth map for the principal layer, allows for an easy implementation of the method on existing devices.

1. Method for encoding 3D video signals wherein an input 3D video signal is encoded, the input 3D video signal comprising a principal video data layer (FR), a depth map for the principal video data layer and comprising further data layers (B1, B2, B1T, B2T) for the principal video data layer, wherein data segments, belonging to different data layers of the principal video data layer, the depth map for the principal video layer and the further data layers, are moved to one or more common data layers (CB1, CB2, C(FR+B1), wherein an additional data stream is generated comprising additional data (M, M1, M2) specifying the original position and/or the original further layer for each moved data segment.

2. Method as claimed in claim 1, wherein the data segments are macroblocks.

3. Method as claimed in claim 1, wherein the further layers comprise image and/or depth data and/or further data from the same point of view as the view for the principal video data layer.

4. Method as claimed in claim 1, wherein only data segments of further data layers (B1, B2, B1T, B2T) are moved to common data layers (CB1, CB2).

5. Method as claimed in claim 1, wherein at least one common data layer comprises data segments of only one type.

6. Method as claimed in claim 5, wherein all common data layers comprises data segments of only one type.

7. Method as claimed in claim 1, wherein at least one common data layer comprises data segments of different types.

8. Method as claimed in claim 7, wherein all common data layers comprise data segments of different types.

9. Method as claimed in claim 1, wherein the data segments are moved to a common layer at the same time slot as the principal video data layer.

10. Method as claimed in claim 1, wherein data segments are moved to a common layer at a different time slot as the principal video data layer and the additional data specifies the time slot difference.

11. Method as claimed in claim 1, wherein the data segments are moved or discarded on basis of priority.

12. System comprising an encoder for encoding a 3D video signal, the encoded 3D video signal comprising a principal video data layer (FR), a depth map for the principal video data layer and further data layers (B1, B2, B1T, B2T) for the principal video data layer, wherein the encoder comprises inputs for the further data layers, the encoder comprises a creator (CR), which combines data segments from more than one data layer of the principal video data layer, the depth map for the principal video data layer and the further data layers into one or more common data layers by moving data segments of the more than one data layers in a common data layer (CB1, CB2, C(FR+B)) and generating an additional data stream (M, M1, M2) comprising data identifying the origin of the moved data segments.

13. System as claimed in claim 12, wherein the data segments are macroblocks.

14. System as claimed in claim 12, wherein the creator creates additional data specifying the further layer of origin.

15. System as claimed in claim 12, wherein the encoder is arranged to move the data segments on basis of priority.

16. System as claimed in claim 12, wherein the creator is arranged to generate a single further data layer.

17. System as claimed in claim 12, wherein the creator combines only data of further data layers in common data layers.

18. Encoder for a system as claimed in any of the claim 12.

19. Method for decoding an encoded video signal wherein a 3D video signal is decoded, the 3D video signal comprising one or more encoded common data layers (CB1, CB1, C(FR+B1)) comprising data segments originating from two or more data layers of a principal video data layer, a depth map for the principal video data layer and further data layers for the principal video layer and comprising an additional data stream (M, M1, M2) comprising additional data specifying the origin of the segments in the common data layers wherein the two or more data layers of a principal video data layer, a depth map for the principal video data layer and further data layers for the principal video layer are reconstructed on the basis of the one or more common data layers (CB1, CB2, C(Fr+B1) and the additional data stream (M, M1, M2) and a 3D image is generated.

20. Method as claimed in claim 19, wherein the two or more common data layers only comprise data segments from further data layers.

21. Method for decoding as claimed in claim 20, wherein the video signal comprises a single common occlusion layer.

22. System comprising a decoder for decoding an encoded video signal wherein a 3D video signal is decoded, the 3D video signal comprising one or more encoded common data layers (CB1, CB1, C(FR+B1)) comprising data segments originating from two or more data layers of an encoded principal video data layer, a depth map for the principal video data layer and one or more further data layers, the 3D video signal further comprising an additional data stream (M, M1, M2) comprising additional data specifying the origin of the segments in the common data layers wherein the decoder comprises a reader for reading the one or more common data layers and the additional data stream, and a reconstructor (RC) for a reconstructing the original principal video data layer, depth map for the principal video data layer and one or more further data layers on the basis of the common data layer and the additional data stream.

23. System as claimed in claim 22 wherein the common data layers only comprise data segments from further data layers and the reconstructor reconstructs the further data layers of origin.

24. Decoder for a system as claimed in claim 22.

25. Computer program comprising program code means for performing a method as claimed in claim 1 when said program is run on a computer.

26. Computer program product comprising program code means stored on a computer readable medium for performing a method as claimed in claim 1.

27. Image signal comprising three dimensional video content, the image signal comprising one or more encoded common data layers (CB1, CB1, C(FR+B1)) comprising data segments originating from two or more data layers of an encoded principal video data layer, a depth map for the principal video data layer and one or more further data layers, the 3D video signal further comprising an additional data stream (M, M1, M2) comprising additional data specifying the origin of the segments in the common data layers.

28. Image signal comprising three dimensional video content, the image signal comprising an encoded principal video data layer, a depth map for the principal video data layer and one or more common data layers (CB1, CB2) comprising data segments originating from different original additional further data layers for the principal video data layer and an additional data stream (M, M1, M2) comprising additional data specifying the origin of the data segments in the common data layers.
